(19) United States
(12) Patent Application Publication
(10) Pub. No.: US 2020/0143598 A1
(43) Pub. Date: May 7, 2020

(54) METHOD OF GENERATING A VIRTUAL DESIGN ENVIRONMENT

(71) Applicant: Joseph RIORDAN, Black Diamond, WA (US)

(72) Inventor: Joseph RIORDAN, Black Diamond, WA (US)

(21) Appl. No.: 16/667,842

(22) Filed: Oct. 29, 2019

Related U.S. Application Data
(60) Provisional application No. 62/755,249, filed on Nov. 2, 2018.
(60) Provisional application No. 62/757,797, filed on Nov. 9, 2018.

(51) Int. Cl. G06T 19/00; G06T 19/20; G06T 17/05; G06F 17/50; G06F 3/0481; G06F 3/0484; G06F 3/0482

(52) U.S. Cl. CPC G06T 19/006; G06T 19/20; G06T 17/05; G06F 3/0482; G06F 3/04815; G06F 3/04845; G06F 17/5009

(57) ABSTRACT

The method of generating a virtual design environment combines on-site geographic information with images of a geographic area to generate an editable, virtual design environment for construction planning, landscaping or the like. A set of geographical coordinates associated with a path followed by a mobile device as the mobile device is transported through a selected geographic region are recorded. An augmented three-dimensional image is then displayed to the user, including a three-dimensional image of the geographic region with a visual representation of the path overlaid thereon. The three-dimensional image of the selected geographic region may be any suitable background image, such as a generic background image, a generic flat surface, a pre-recorded image of the geographic region or an image made on-site. The augmented three-dimensional image may then be edited by adding at least one selected design element thereto using the visual representation of the path as a geographical reference.

### CROSS-REFERENCE TO RELATED APPLICATION

This application claims the benefit of U.S. Provisional Patent Application Ser. No. 62/755,249, filed Nov. 2, 2018, and U.S. Provisional Patent Application Ser. No. 62/757,797, filed on Nov. 9, 2018.

### BACKGROUND

### 1. Field

The disclosure of the present patent application relates to virtual design environments for designing construction projects, landscaping projects or the like, and particularly to a method of generating a virtual design environment combining on-site geographic information with a three-dimensional image of a geographic area to generate an editable, virtual design environment.

### 2. Description of the Related Art

Design software has long been used in landscaping, architecture and construction to simulate what a proposed design would look like at a particular location. Until recently, the hack ground image of the location wag typically a crude, computer-generated representation. In recent years, with the advent of realistic photo manipulation and computer generated imagery, actual photographic images of the backgrounds have been used, with the desired design elements overlaid thereon. Such design software, although greatly advanced from earlier versions thereof, is still limited in its ability to realistically depict a finished design, particularly due to the background images typically being two-dimensional images.

The use of solely two-dimensional images of the geographic locations makes proper scaling and positioning of the added design elements difficult. Additionally, important information, such as the particular contour of the ground, can be missing or obscured in a two-dimensional representation of the geographic location. Further, such design software is typically used off-site, i.e., images of a geographic location are typically recorded, with conventional digital cameras or the like, and the recorded data is then saved for manipulation on remote computers, typically located in the offices of design, landscaping or architectural firms. It would obviously be desirable to be able to record images at the selected geographic location and perform the design-based editing of those images at the same location. Thus, a method of generating a virtual design environment solving the aforementioned problems is desired.

### SUMMARY

The method of generating a virtual design environment combines on-site geographic information with images of a geographic area to generate an editable, virtual design environment for construction planning, landscaping or the like. A set of geographical coordinates associated with a path followed by a mobile device as the mobile device is transported through a selected geographic region are recorded. An augmented three-dimensional image is then displayed to the user, including a three-dimensional image of the selected geographic region with a visual representation of the path overlaid thereon. The three-dimensional image of the selected geographic region may be any suitable background image, such as, for example, a generic background image, a generic flat surface, a pre-recorded image of the geographic region or, as will be described in further detail below, an image made on-site.

The augmented three-dimensional image may then be edited by adding at least one selected design element thereto using the visual representation of the path as a geographical reference. In the particular case where the background image is generated on-site, a set of visual images of the selected geographic region are recorded with a camera associated with the mobile device as the mobile device is transported along the path in the geographic region. Each recorded visual image is geotagged with geographical coordinates associated with the visual image. A set of geographical coordinates associated with the path are also recorded as the camera is transported along the path. The three-dimensional image of the selected geographic region is then generated from the set of visual images, and the augmented three-dimensional image is displayed, including the three-dimensional image of the selected geographic region with a visual representation of the path overlaid thereon. In this case, the visual representation of the path is positioned with respect to the three-dimensional image of the selected geographic region by a comparison between the geographical coordinates associated with each visual image used to construct the three-dimensional image and the set of geographical coordinates associated with the path.

The augmented three-dimensional image may then be edited by adding at least one selected design element thereto using the visual representation of the path as a geographic reference. The at least one design element may be construction-related, such as a house, building, roadway, etc., landscaping-related, such as trees, bushes, flowers, grass, etc., or may be any other desired design feature. The at least one selected design element may be selected from a menu of design elements, or the user may, alternatively, input drawing design data to at least partially draw the at least one selected design element on the augmented three-dimensional image. Once the user has completed the editing of augmented three-dimensional image, either permanently or temporarily, the augmented three-dimensional image may be saved in local memory of the mobile device and/or may be uploaded to an external server or separate device.

In the case where the mobile device uses a camera to generate the background image, the camera of the mobile device typically begins recording images (and the GPS coordinates also begin recording) at the beginning of the path traveled by the user, and the recording typically ceases at the end of the path. However, it should be understood that the user may also pause recording at any point or points during the travel of the user and mobile device. Further, in addition to editing the three-dimensional image, the user may also edit the visual representation of the path, such as by changing the shape, size and/or location of the visual representation of the path in the augmented three-dimensional image. It should be further understood that, in addition to editing the graphical features associated with the design elements, the user may also add text to the image(s), such as by inserting labels and notes associated with individual design elements or particular regions of augmented three-dimensional image.

Although each of the above examples represents an aboveground design element, the selected design element may also be a belowground design element, such as a buried pipe, cable or the like. In the belowground case, the augmented three-dimensional image may include representations of both the aboveground environment and the belowground environment, with proper positioning of the belowground design element being performed using any input depth information that is available. Additionally, it should be understood that any additional conventional graphical editing may be applied to the inserted design elements or the augmented three-dimensional image. For example, in the belowground case, local regulations typically govern the color and/or style of markers made on the ground. The user may edit the color and/or style of such markers to comply with local regulations.

These and other features of the present subject matter will become readily apparent upon further review of the following specification and drawings.

### BRIEF DESCRIPTION OF THE DRAWINGS

FIG. 1 is a diagrammatic top view of a path through a geographical area and successive positions of a mobile device along the path as an initial step in a method of generating a virtual design environment.

FIG. 2 is a screenshot showing an exemplary augmented three-dimensional image of a geographical region with a visual representation of the path overlaid thereon.

FIG. 3 is a screenshot showing a menu of exemplary design elements presented to the user to further augment the three-dimensional image of FIG. 2.

FIG. 4 is a screenshot showing the augmented three-dimensional image of FIG. 2 after addition of selected exemplary design elements to the image.

FIG. 5 is a diagrammatic top view of a path through a geographical area and successive positions of a mobile device along the path as an initial step of the method of generating a virtual design environment in an alternative example.

FIG. 6 is a screenshot showing an exemplary augmented three-dimensional image of a geographical region with a visual representation of the path overlaid thereon using the alternative example of FIG. 5.

FIG. 7 is a screenshot of the augmented three-dimensional image of FIG. 6 after addition of selected exemplary design elements to the image.

FIG. 8 is a diagrammatic top view of a path through a geographical area and successive positions of a mobile device along the path as an initial step in a method of generating a virtual design environment in another alternative example.

FIG. 9 is a screenshot of an augmented three-dimensional image of the geographical area of FIG. 8 after addition of selected design elements to the image.

FIG. 10 is a block diagram of a system used in the method of generating a virtual design environment.

Similar reference characters denote corresponding features consistently throughout the attached drawings.

### DETAILED DESCRIPTION OF THE PREFERRED EMBODIMENTS

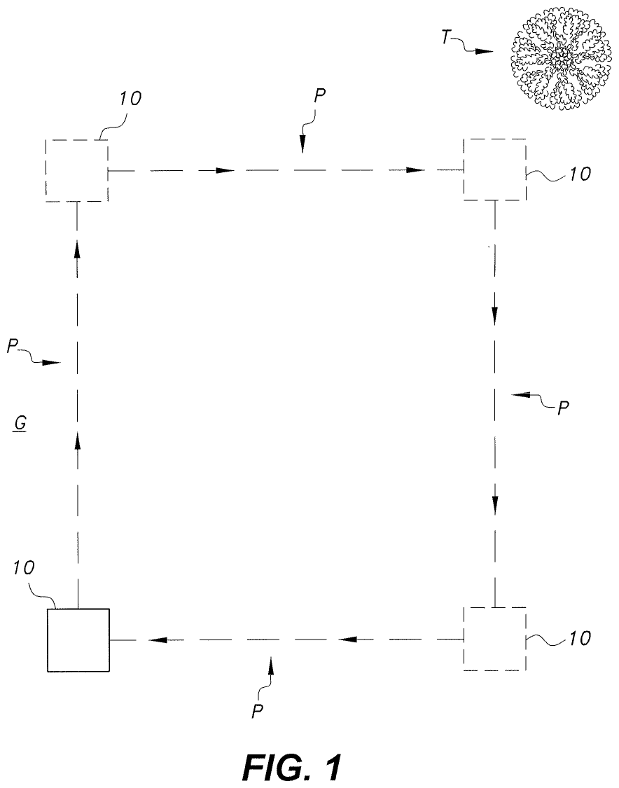

The method of generating a virtual design environment combines on-site geographic information with images of a geographic area to generate an editable, virtual design environment for construction planning, landscaping or the like. As illustrated in FIG. 1, as the user carries a mobile device 10 across the ground G within a selected geographic region, a set of geographical coordinates associated with a path P followed by the mobile device 10, as the mobile device 10 is transported through the selected geographic region, are recorded. An augmented three-dimensional image I is then displayed to the user, including a three-dimensional image of the selected geographic region with a visual representation of the path overlaid thereon (i.e., path overlay PO). The three-dimensional image of the selected geographic region may be any suitable background image, such as, for example, a generic background image, a generic flat surface, a pre-recorded image of the geographic region or an image made on-site.

In the particular case of the background image being made on-site, as opposed to being a generic background or the like, a set of visual images of the selected geographic region are recorded with a camera 24, visual sensor or the like, which is associated with mobile device 10, as the camera 24 is transported along the path P within the geographic region. Each recorded visual image is geotagged with geographical coordinates associated with the visual image.

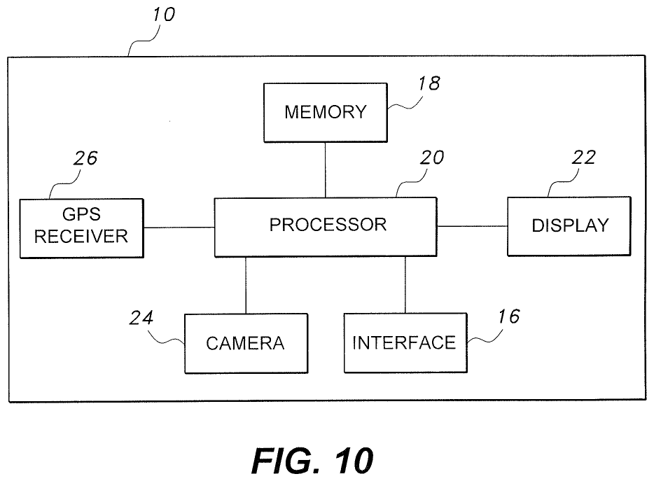

The mobile device 10 may be any suitable type of portable or mobile device (or collection of interconnected devices) that is capable of recording at least geographic data and, in the case discussed above with regard to on-site image generation, also capable of recording image data. For example, the mobile device 10 may be a smartphone equipped with at least one camera and a global positioning system (GPS) receiver. However, it should be understood that the recordation of the image data and geographic data, as well as the processing thereof, as will be described in greater detail below, may be performed by any suitable computer or computerized system, such as that diagrammatically shown in FIG. 10. Data is entered into the device 10 via any suitable type of user interface 16, and may be stored in memory 18, which may be any suitable type of computer readable and programmable memory and is preferably a non-transitory, computer readable storage medium. Calculations are performed by processor 20, which may be any suitable type of computer processor and may be displayed to the user on display 22, which may be any suitable type of display. In a conventional smartphone, for example, the display 22 and the interface 16 are typically integrated into a single touchscreen. Conventional smartphones, as a further example, are typically equipped with one or more integrated cameras 24 and a GPS receiver 26, although it should be understood that any suitable type of camera, visual sensor or the like, as well as any receiver of geographical coordinate data, may be utilized.

The processor 20 may be associated with, or incorporated into, any suitable type of computing device, for example, a smartphone, a laptop computer or a programmable logic controller. The display 22, the processor 20, the memory 18, the camera 24, the GPS receiver 26, and any associated computer readable recording media are in communication with one another by any suitable type of data bus, as is well known in the art.

Examples of computer-readable recording media include non-transitory storage media, a magnetic recording apparatus, an optical disk, a magneto-optical disk, and/or a semiconductor memory (for example, RAM, ROM, etc.). Examples of magnetic recording apparatus that may be used in addition to memory 18, or in place of memory 18, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. It should be understood that non-transitory computer-readable storage media include all computer-readable media, with the sole exception being a transitory, propagating signal.

Returning to FIG. 1, it should be understood that the rectangular path P that the user walks over ground G, carrying mobile device 10, is shown for exemplary purposes only, and that path P may follow any desired route. Similarly, it should be understood that the single tree T is shown for illustrative and exemplary purposes only. A set of geographical coordinates associated with the path P are also recorded by the GPS receiver 26 as the mobile device 10 is transported along the path P.

In the case where camera 24 is used, although the extent of images recorded (both in number and geographic range) is user selectable, the camera 24 typically may begin recording images (and the GPS coordinates would begin being recorded) at the beginning of the path P and cease recording at the end of the path P. It should be understood that the user may also pause recording at any point or points during the travel of the user and the mobile device 10. Further, in addition to the path P, other geographic features and locations may be indicated and recorded, such as a land property boundary.

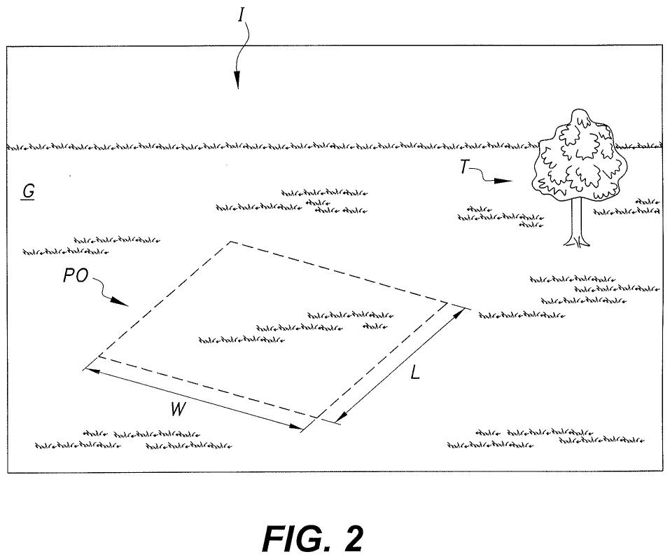

Returning to FIG. 2, in the case where the three-dimensional image is generated on-site by usage of camera 24, the three-dimensional image of the selected geographic region is generated from the set of recorded visual images, and the augmented three-dimensional image I is displayed, which includes the three-dimensional image of the selected geographic region with a visual representation of the path overlaid thereon. Alternatively, as described above, the background image may be a generic background image, a generic flat surface, a pre-recorded image of the geographic region, a user-drawn image or the like.

In FIG. 2, the path overlay PO is shown as having a rectangular configuration, along with a known length L and a known width W (calculated from the set of geographical coordinates associated with path P as recorded by GPS receiver 26 as mobile device 10 was transported along path P). However, it should be understood that the screenshot of FIG. 2, including the path overlay PO, is shown solely for illustrative and exemplary purposes only, and is shown with path overlay PO being rectangular and having particular exemplary dimensions solely to match with the rectangular path P shown in the example of FIG. 1.

In the case where the background image is generated on-site, the visual representation of the path P is positioned with respect to the three-dimensional image I of the selected geographic region by a comparison between the geographical coordinates associated with each visual image used to construct the three-dimensional image I and the set of geographical coordinates associated with path P. One having ordinary skill in the art would recognize that three-dimensional reconstruction of images from multiple two-dimensional images is well known, and it should be understood that any suitable process for constructing the three-dimensional image of the selected geographic region based on the recorded camera images may be used. For example, techniques that may be utilized include passive triangulation, passive stereo, structure-from-motion, active triangulation, time-of-flight techniques, shape-from-shading techniques, photometric stereo, shape-from-texture techniques, shape-from-contour techniques, shape-from-defocus techniques, shape-from-silhouette techniques and the like.

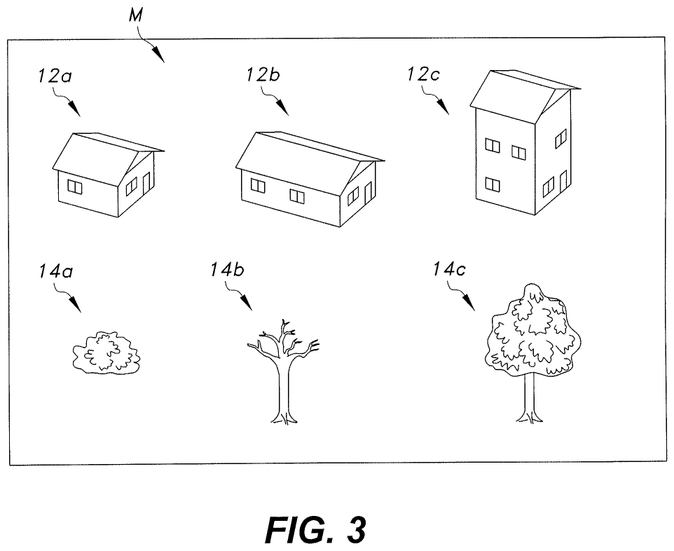

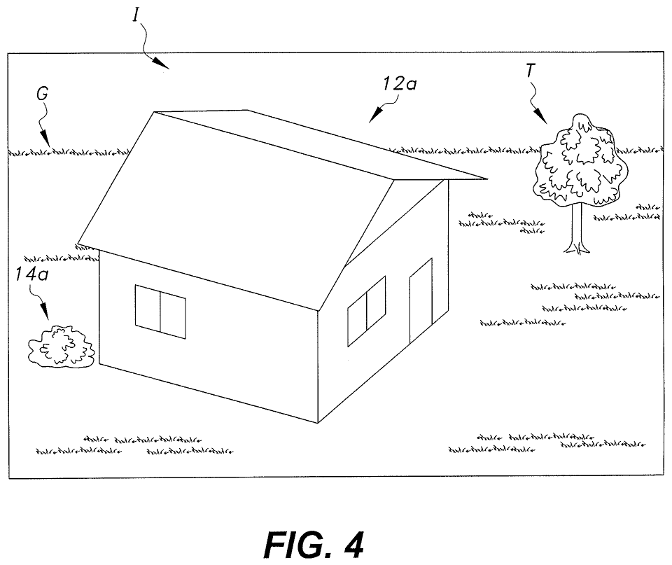

The augmented three-dimensional image I may then be edited by adding at least one selected design element thereto using the visual representation of the path P as a geographic reference. The at least one design element may be construction-related, such as a house, building, roadway, etc.; landscaping-related, such as trees, bushes, flowers, grass, etc.; or may be any other desired design feature. As shown in FIG. 3, the at least one selected design element may be selected from a menu M of design elements. In the exemplary screenshot of FIG. 3, menu M only includes three sample houses 12a, 12b, 12c and three sample landscaping items, including bush 14a and trees 14b, 14c. It should be understood that the particular design elements illustrated in menu M of FIG. 3 are shown for purposes of illustration and example only, and that menu M may include both a wider variety of each type of design element, and may also include further types and styles of design elements. In the example of FIG. 4, the user has selected house 12a and bush 14a from menu M of FIG. 3, and the house 12a is properly scaled to use path overlay PO as a position for the base of the house 12a. Further, in addition to editing the three-dimensional image, the user may also edit the path overlay PO, such as by changing the shape, size and/or location of path overlay PO in the augmented three-dimensional image I.

The user may further edit the image I to change the location of the house 12a, replace the house 12a with another design element, rescale the house 12a, add any additional design elements, such as a bush 14a, in any desired locations, as well as modifying existing elements, such as the tree T. Further, the features of any design element may also be edited. For example, if the house 12a is selected, the user may use graphical editing software to change the type of roof, the color of the house, the location of a door, etc. In the example of FIG. 3, the user is presented with a graphical menu M. However, it should be understood that the user may, alternatively, input drawing design data to at least partially draw the at least one selected design element on the augmented three-dimensional image I. Computer aided design (CAD) software, along with drawing and sketching software, are well known in the art, and it should be understood that any suitable type of CAD, drawing, sketching or other design software may be used to allow the user to input drawing design data to at least partially draw the at least one selected design element on the augmented three-dimensional image I. It should be further understood that, in addition to editing the graphical features associated with the design elements, the user may also add text to the image(s), such as by inserting labels and notes associated with individual design elements or particular regions of augmented three-dimensional image I. Once the user has completed the editing of augmented three-dimensional image I, either permanently or temporarily, the augmented three-dimensional image I may be saved in local memory 18 of the mobile device 10 and/or may be uploaded to an external server or separate device.

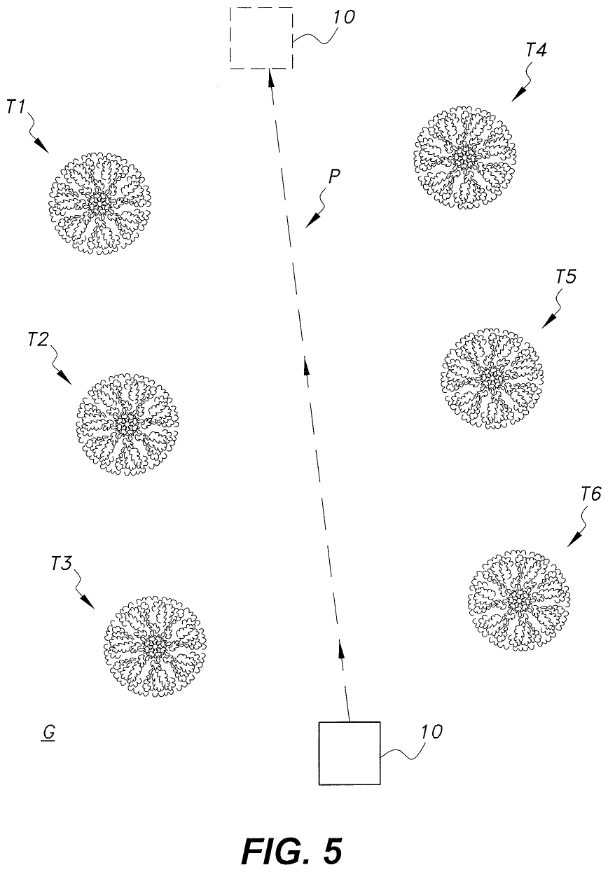

In the further example of FIG. 5, the user carries the mobile device 10 along a relatively straight line path P over ground G through a geographic region containing numerous trees T1-T6. In this particular example, the user wishes to design a road that will pass through the trees T1-T6 and has walked the desired path P. It should be understood that the path P and the locations of the trees T1-T6 are shown for illustrative and exemplary purposes only, and that path the P could be more complex, including curves, for example, and trees T1-T6 could be replaced with any other type of environmental obstacle.

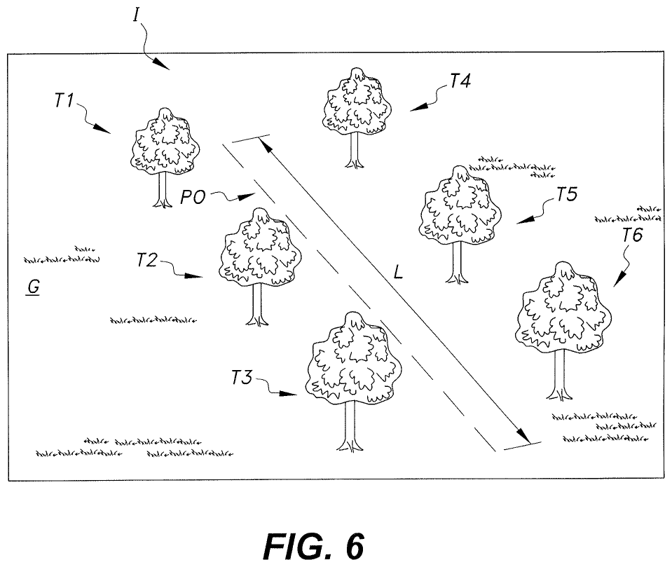

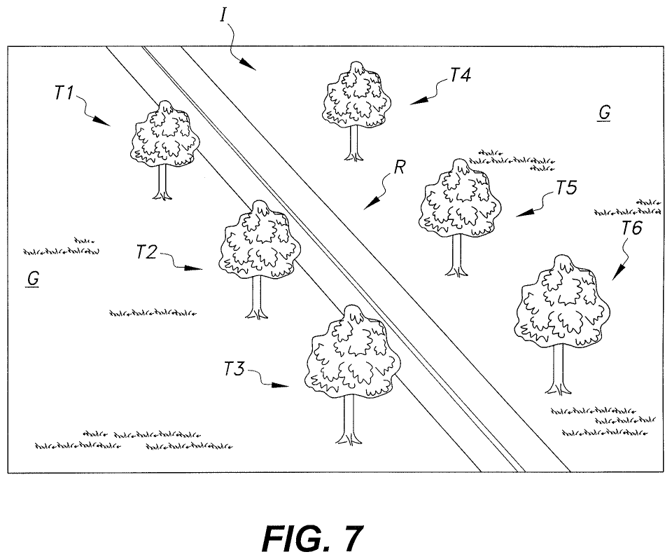

Following the method of generating a virtual design environment, as described above, FIG. 6 is similar to FIG. 2, with a three-dimensional image of the selected geographic region being generated from the set of visual images recorded by the camera 24 of the mobile device 10, and with augmented the three-dimensional image I being displayed, including the three-dimensional image of the selected geographic region, with a visual representation of the path overlaid thereon. As described above with respect to the previous example, the user may then be presented with a menu M, where he or she may select images of roads, for example, to be positioned over path overlay PO. In FIG. 7, an exemplary selected road R is shown positioned over the path overlay PO.

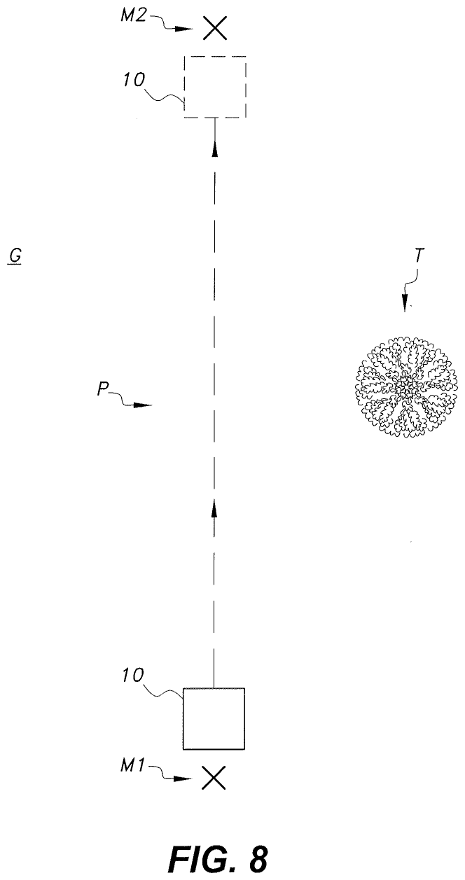

Although each of above examples represents an aboveground design element, the selected design element may also be a belowground design element, such as a buried pipe, cable or the like. In the example of FIG. 8, the user follows a path P over ground G in which an exemplary pipe is buried. It should be understood that any suitable type of belowground element may be buried in the ground G. The locations of belowground elements, such as buried pipes, cables, wires, etc. are typically marked on the ground using paint or the like, and FIG. 8 shows two such markers M1, M2 showing the endpoints of the buried pipe. It should be understood that the desired location of a belowground element that is to be buried, rather than being already buried, may also be marked off and recorded by the path P walked by the user. It should be understood that the particular terrain, along with the tree T, are shown for exemplary purposes only.

Typically, pre-existing belowground elements, such as pipes, conduits, cables, tanks, etc., are first identified using conventional methods, such as metal detectors, surface exposure, digging and the like. Once the belowground elements have been identified, the location is typically marked on the ground with paint, dye, stakes or the like. It should be understood that the location of the belowground elements in the present method may be identified using any suitable method, and that markers M1, M2 may be made using any type of suitable process.

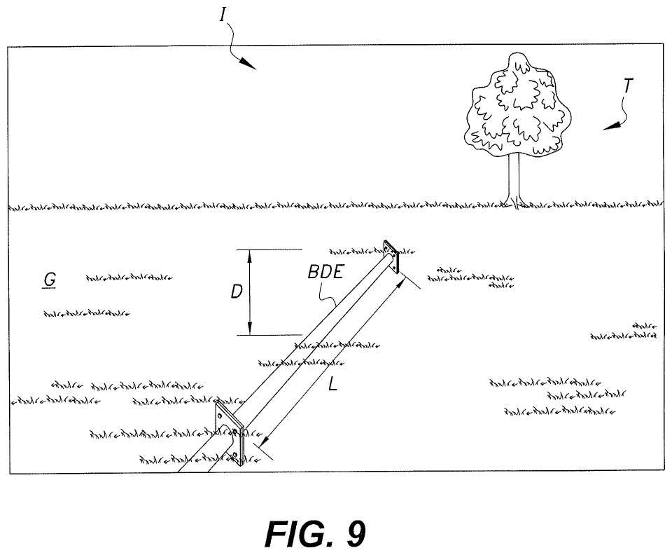

In this belowground example, the augmented three-dimensional image I may include representations of both the aboveground environment and the belowground environment, as shown in FIG. 9. As in the previous embodiments, the length L of the exemplary pipe (or other belowground element) may be measured using the recorded GPS coordinates of the path P. Proper positioning of the belowground design element BDE may be performed using any input depth information that is available, i.e., if the user knows the depth D of a buried pipe (or knows the depth at which the pipe should later be buried), this depth D is input via the interface 16 and the belowground design element BDE may be positioned in image I and properly scaled based on this input depth D. As in the previous examples, the user may select the image of belowground design element BDE from a menu of options, or may at least partially draw or sketch the image using any suitable type of CAD, drawing or sketching software. Once the user has completed the editing of the augmented three-dimensional image I, either permanently or temporarily, the augmented three-dimensional image I may be saved in local memory 18 of the mobile device 10 and/or may be uploaded to an external server or separate device.

In the case of belowground elements, since depth may be used as a design factor, when the user walks path P with the mobile device 10, the mobile device 10 should be held at a constant height above the ground G. As in the previous examples, camera 24 would typically begin recording images (and the GPS coordinates would begin being recorded) at the beginning of the path P (i.e., at marker M1) and would cease at the end of the path P (i.e., at marker M2). It should be understood that the user may also pause recording at any point or points during the travel of the user and the mobile device 10. Further, similar to the previous examples, in addition to editing the three-dimensional image, the user may also edit the path overlay PO, such as by changing the shape, size and/or location of the path overlay PO in the augmented three-dimensional image I.

It should be further understood that, similar to the previous examples, in addition to editing the graphical features associated with the design elements, the user may also add text to the image(s), such as by inserting labels and notes associated with individual design elements or particular regions of the augmented three-dimensional image I. Additionally, it should be understood that any additional conventional graphical editing may be applied to the inserted design elements or the augmented three-dimensional image I. For example, in the belowground example, local regulations typically govern the color and/or style of markers, such as markers M1 and M2, made on the ground. The user may edit the color and/or style of markers M1 and M2 to comply with local regulations.

It is to be understood that the method of generating a virtual design environment is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

I claim:

1. A method of generating a virtual design environment, comprising the steps of:
recording a set of geographical coordinates associated with a path followed by a mobile device as the mobile device is transported through a selected geographic region;
displaying an augmented three-dimensional image including a three-dimensional image of the selected geographic region with a visual representation of the path overlaid thereon; and
editing the augmented three-dimensional image by adding at least one selected design element thereto using the visual representation of the path as a geographical reference.

2. The method of generating a virtual design environment as recited in claim 1, wherein the mobile device comprises a camera.

3. The method of generating a virtual design environment as recited in claim 2, further comprising the step of recording a set of visual images of the selected geographic region with the camera as the camera is transported along the path in the selected geographic region.

4. The method of generating a virtual design environment as recited in claim 3, further comprising the step of geotagging each of the visual images with geographical coordinates associated with the visual image.

5. The method of generating a virtual design environment as recited in claim 4, wherein the three-dimensional image of the selected geographic region is generated from the set of visual images.

6. The method of generating a virtual design environment as recited in claim 5, wherein the visual representation of the path is positioned with respect to the three-dimensional image of the selected geographic region by comparison between the geographical coordinates associated with each of the visual images and the set of geographical coordinates associated with the path.

7. The method of generating a virtual design environment as recited in claim 1, wherein the step of editing the augmented three-dimensional image comprises adding at least one construction-related design element thereto.

8. The method of generating a virtual design environment as recited in claim 1, wherein the step of editing the augmented three-dimensional image comprises adding at least one landscaping-related design element thereto.

9. The method of generating a virtual design environment as recited in claim 1, wherein the step of editing the augmented three-dimensional image comprises adding at least one aboveground design element thereto.

10. The method of generating a virtual design environment as recited in claim 1, wherein the step of editing the augmented three-dimensional image comprises adding at least one belowground design element thereto.

11. The method of generating a virtual design environment as recited in claim 10, wherein the step of editing the augmented three-dimensional image further comprises positioning the at least one belowground design element based on input depth data associated with the at least one belowground design element.

12. The method of generating a virtual design environment as recited in claim 1, wherein the step of editing the augmented three-dimensional image comprises selecting the at least one selected design element from a menu of design elements.

13. The method of generating a virtual design environment as recited in claim 1, wherein the step of editing the augmented three-dimensional image comprises inputting drawing design data to at least partially draw the at least one selected design element on the augmented three-dimensional image.

14. The method of generating a virtual design environment as recited in claim 1, further comprising the step of further editing the augmented three-dimensional image with at least one textual element.
